(19) United States
(12) Patent Application Publication
(10) Pub. No.: US 2016/0217232 A1
(43) Pub. Date: Jul. 28, 2016

(54) INTERACTIVE USER INTERFACE DRIVEN BY A SIMULATION ENGINE AND KNOWLEDGE REPOSITORY AND A METHOD OF USING THE SAME

(71) Applicant: Carrier Corporation, Farmington, CT (US)

(72) Inventors: Bradley D. Powell, Greenwood, IN (US); Rajendra K. Shah, Indianapolis, IN (US); Mario Lazaga, Indianapolis, IN (US)

(21) Appl. No.: 14/994,931

(22) Filed: Jan. 13, 2016

Related U.S. Application Data
(60) Provisional application No. 62/108,898, filed on Jan. 28, 2015.

(51) Int. Cl. G06F 17/50; G06F 3/0484

(52) U.S. Cl. CPC G06F 17/5009; G06F 3/04842

(57) ABSTRACT

A device for displaying context relative content using an interactive simulator, the device including a processor, a memory, a display, one or more programs stored in said memory and configured to be executed by said processor, wherein said programs are configured to simulate commands to operate a system; and operate a graphical user interface of the system on said display, said graphical user interface comprising a simulated user interface, and a context relative side-bar.

### CROSS REFERENCE TO RELATED APPLICATIONS

The present application is related to, and claims the priority benefit of, U.S. Provisional Patent Application Ser. No. 62/108,898 filed Jan. 28, 2015, the contents of which are hereby incorporated in their entirety into the present disclosure.

### TECHNICAL FIELD OF THE DISCLOSED EMBODIMENTS

The presently disclosed embodiments are generally related to control system emulators, and more particularly, to an interactive use interface driven by a simulation engine and knowledge repository and a method of using the same.

### BACKGROUND OF THE DISCLOSED EMBODIMENTS

Modern buildings have sophisticated technologies such as security, fire safety, building automation, ventilation, and refrigeration systems. These systems often include a control system configured to communicate with the equipment in order to manage and operate the systems. Heating, ventilating, and air conditioning (HVAC) systems, to use one non-limiting example, are prevalent in today's modern buildings. Often, such systems are composed of numerous types of equipment with each type of equipment having different possible configurations. When interconnected, the equipment delivers a large number of features. The operation controls, and management of these systems can become sophisticated, requiring information and expertise to properly install, operate and repair. Parties involved in the deployment, management and maintenance of such HVAC systems can include, for example, designers, engineers, salesmen, installers, service technicians, and end users. Each of these parties requires distinct information to help facilitate their roles and responsibilities. Hence, each of these parties has a need for specialized information. Today, this information is often scattered in various knowledge repositories that comprise of traditional static documents. These knowledge repositories are difficult to maintain, outdated, incomplete or inconsistent with one another. Furthermore, the presentation of such information to parties seeking knowledge is also cumbersome thereby limiting its usefulness.

Often, such information requires continuous updates to reflect the changes in features, functionality and operability of the HVAC systems. This need to keep the information “ever-green” presents obstacles. Current knowledge repositories usually involve a collection of static documents. These documents can become excessively large in terms of volume and depth of information. Additionally, the responsibility for the maintenance of the knowledge repositories can fall on various stakeholders, such as organizations, and individuals. This presents an added problem because each stakeholder, working independently, might create disparate copies of the same information. A stakeholder can end up operating on an outdated knowledge repository; or a stakeholder might incorrectly update information thereby leading to more confusion for the end user.

Additionally, when a system includes multiple integrated components, the expertise required to properly install, operate and maintain such systems correspondingly increases. Consequently, the knowledge transfer to develop said expertise becomes even more crucial. Generally, when components are integrated, the features of each component may be documented in disparate knowledge repositories respective to each component of the integrated system. As such, the information has to be manually assimilated. The assimilation of such information, at times, may be tedious and so overtly cumbersome so as to preclude any attempt to obtain the information from the knowledge repositories.

Additionally, the various stakeholders have different knowledge needs. For example, an end user of a system might require basic information such as turning on or off the system; a maintenance technician might require knowledge pertaining to diagnostics; an installer might need information on configuration; and a salesman might require information about system capabilities. The information presented to each stakeholder must be pertinent, useful and accurate. To maximize the benefits, the information must be presented in a manner that is convenient to use by the user. Currently, the information is presented via static mediums such as print material or electronic webpages. Hence, the information presented is very passive (i.e., the user simply reads the information and does not require interaction). Additionally, the static content does not always deliver information that is pertinent to the stakeholder seeking the information. This rudimentary approach to knowledge transfer is limited in its effectiveness given the passive and static nature of the medium.

Finding an efficient, effective and value added way to gather, organize, integrate, manage, and present data to users of such systems would dramatically improve their experience. There also exists a need for a simulator that allows a user to easily obtain information regarding each feature of the component. Accordingly, there exists a need for a system and method for an interactive user interface driven by simulation engine and knowledge repository.

### SUMMARY OF THE DISCLOSED EMBODIMENTS

In one aspect a device for displaying context relative content using an interactive simulator is provided. The device includes a display, a processor, and a memory. One or more programs are stored in memory, and the programs are configured to simulate commands to operate a system. In one embodiment, the system includes an HVAC system.

The programs are further configured to operate a graphical user interface (GUI) on the display, the GUI including a simulated user interface and a context relative side-bar. In one embodiment, the simulated user interface is configured to simulate an HVAC system controller. In one embodiment, the context relative side-bar is configured to dynamically display context relative information based at least in part on interactions with the simulated user interface, and a selected at least one component and/or a user defined role.

In one embodiment, the GUI further includes a configuration module. The configuration module is configured to allow a user to select at least one component for simulation. In one embodiment, the at least one component is selected from a group consisting of indoor units, outdoor units, and accessories. In one embodiment, the configuration module is further configured to allow the user to select a user define role. In one embodiment, the user defined role is selected from a group consisting of internal users and external users.

A method for displaying context relative content on a device is provided. The method includes the step of interacting with the simulated user interface, and dynamically displaying context relative information in the context relative side-bar. In one embodiment, the method includes the step of interacting with the configuration module to select at least one component for simulation. In one embodiment, the method further includes the step of interacting with the configuration module to select a user defined role.

### BRIEF DESCRIPTION OF DRAWINGS

FIG. 1 illustrates a schematic block diagram of a device for operating an interactive simulation engine and knowledge repository according to at least one embodiment of the present disclosure;

FIG. 2 illustrates a schematic diagram of a graphic user interface used with an interactive simulation engine and knowledge repository according to at least one embodiment of the present disclosure;

FIG. 3 illustrates a schematic flowchart of a method of displaying context relative information on a device according to at least one embodiment of the present disclosure;

FIG. 4 illustrates a schematic diagram of a simulated user interface according to at least one embodiment of the present disclosure;

FIG. 5 illustrates a schematic diagram of a context relative side bar according to at least one embodiment of the present disclosure; and

FIG. 6 illustrates a schematic diagram of a configuration module according to at least one embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

As used in the present disclosure, a stakeholder may include, but is not limited to, a designer, a manufacturer, a vendor, a salesperson, an installer, a service technician, an end user, an organization, an entity or any other individual.

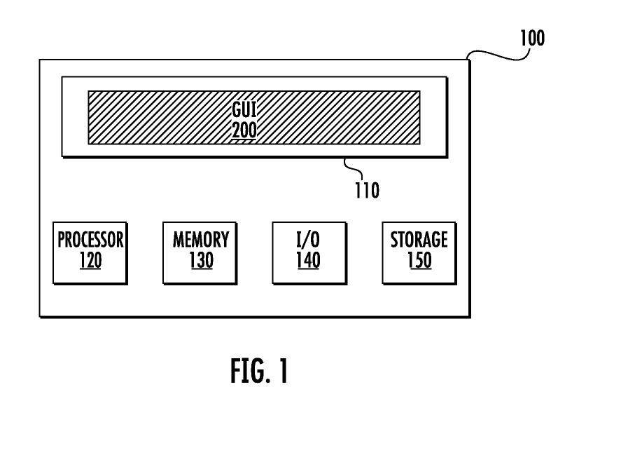

FIG. 1 illustrates a device for displaying context relative content using an interactive simulator, generally indicated at 100. It will be appreciated that device 100 may include one or more computers, smartphones, tablets, wearable technology, computing devices, touch screen devices, display monitors, thermostat, system controller or systems of a type well known in the art, such as a mainframe computer, workstation, personal computer, laptop computer, hand-held computer, cellular telephone, or personal digital assistant to name a few non-limiting examples.

The device 100 includes a display 110. The display 110 may include various types of known displays such as liquid crystal diode displays, light emitting diode display, touch screens, and the like upon which information may be display in a manner perceptible to the user.

The device 100 further includes a processor 120 and a memory 130. Memory 130 may include high-speed random access memory, non-volatile memory, such as one or more magnetic disk storage devices, flash memory devices, other non-volatile solid-state memory devices, or as would occur to one of skill in the art. One or more programs are stored in memory 130 and the programs are configured to be executed by the processor 120. The programs are configured to simulate commands to operate a system. In one embodiment, the system includes an HVAC system. It will be appreciated that the system may include any system such as, elevator, escalator, fire safety, security, building automation, heating, ventilation, air conditioning and refrigeration systems, to name a few non-liming examples. The programs are further configured to operate a graphical user interface (GUI) 200 on the display 110.

It will be appreciated that the device 100 may include I/O devices 140. I/O devices 140 includes of one or more operable devices for data entry, such as, for example, a pointing device (such as a mouse), keyboard, touchscreen, microphone, voice recognition, and/or other data entry means known in the art. It will be appreciated that the device 100 may be communicatively coupled to a storage device 150. In the embodiment shown, storage device 150 is an integrated part of the device 100; however, the storage device 150 may be external to the device 100, for example a server, via a network (not shown) to name one non-limiting example. For the purpose of clarity, only one device 100 is shown in FIG. 1; however, it should be appreciated that a plurality of devices 100 may be used concurrently.

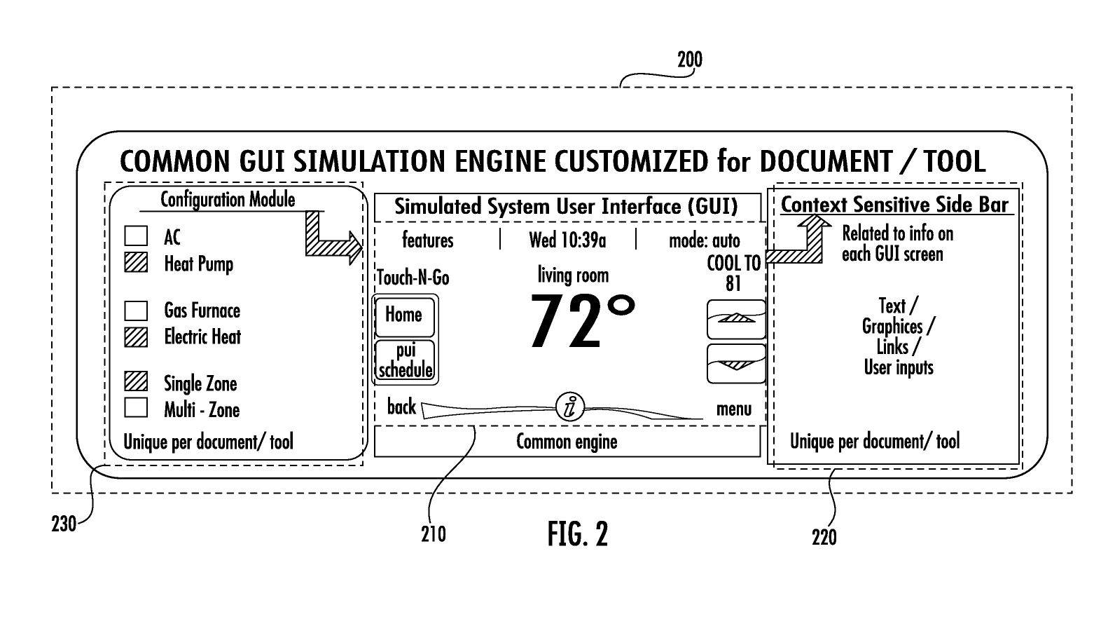

FIG. 2 illustrates an embodiment of the GUI 200 shown on the display 110. The GUI 200 includes a simulated user interface 210. The simulated user interface 210 is configured to substantially mimic an interface used to interact with the system being simulated. In one embodiment, the simulated user interface 210 is configured to simulate an HVAC system controller.

The GUI 200 further includes a context relative side-bar 220. In one embodiment, the context relative side-bar 220 is configured to dynamically display context relative information based at least in part on interactions with the simulated user interface 210. In another embodiment, the context relative side-bar 220 is configured to dynamically display context relative information based at least in part on a interactions with the simulated user interface 210, and a selected at least one component, and/or a user defined role selected from a configuration module 230. It will be appreciated that the context side-bar 220 may display any format of information such as, for example, bulleted points, tables, diagrams, pictures, text, video, and any other format appreciated in the arts.

In one embodiment, the GUI 200 further includes a configuration module 230. The configuration module 230 is configured to allow a user to select at least one component for simulation. In one embodiment, the at least one component is selected from a group consisting of HVAC indoor units, HVAC outdoor units, and HVAC accessories. It will be appreciated that accessories include, but are not limited to humidifiers, dehumidifiers, indoor air quality products, auxiliary heating, and Wi-Fi, to name a few non-limiting examples. In one embodiment, the configuration module 230 is further configured to allow the user to select a user defined role. In one embodiment, the user defined role is selected from a group consisting of internal users and external users. For example, if the user is an engineer or inside sales manager, the user may select the user defined role of an internal user. Alternatively, if the user is a homeowner, the user may select the user defined role of an external user.

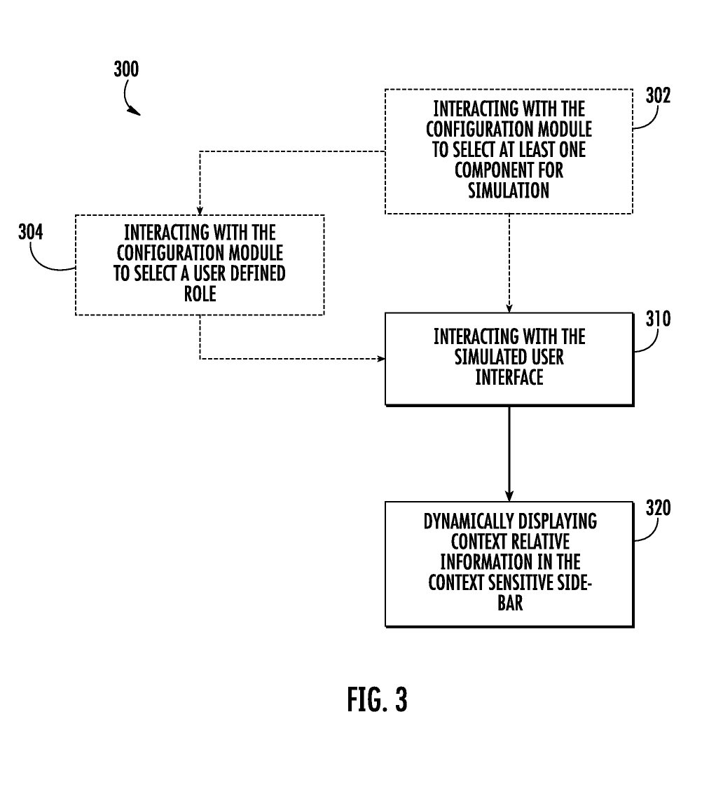

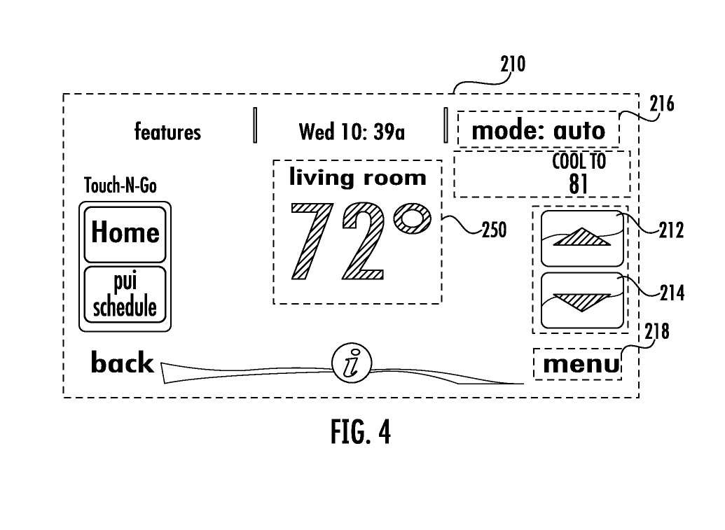

FIG. 3 illustrates a method for displaying context relative content using the device 100, the method generally indicated at 300. The method 300 includes step 310 of interacting with the simulated user interface 210. For example, referring to FIG. 4, the user may interact with the simulated user interface 210, for an HVAC system, to simulate the adjustment of temperature using interactions 212 and 214; change the system mode using interaction 216, or view additional simulated functional information using interaction 218 to name a few non-limiting examples. It will be appreciated that the simulated user interface 210 may also simulate additional information, such as, error messages, troubleshooting steps, equipment information, and diagnostic information to name a few non-limiting examples. It will be also appreciated that interaction with the simulated user interface may be accomplished by operating the 110 device 140, touching the display 110, or any other means appreciated in the arts.

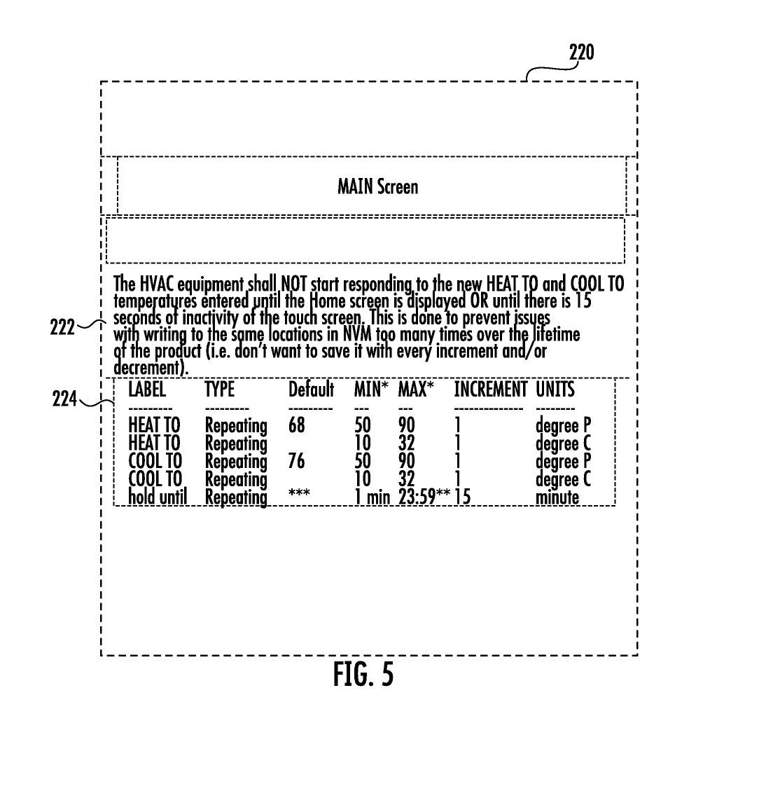

Referring back to FIG. 3, the method further includes the step 320 of dynamically displaying context relative information in the context relative side-bar 220. In one embodiment, the context relative information is based at least in part on the interactions with the simulated user interface 210. For example, if the user interacts with temperature interactions 212 or 214 (See FIG. 4), the program accesses a file within storage 150 (See FIG. 1) to display context relative information within the context relative side-bar 220 based on said interactions. The context relative information 222 and 224 (See FIG. 5) provides a visual explanation of the function of the interaction (e.g. temperature controls) to help inform the user of the operation and purpose of said interaction. It will be appreciated that the context relative information 222 and 224 are dynamically updated based on the interactions with the simulated user interface 210.

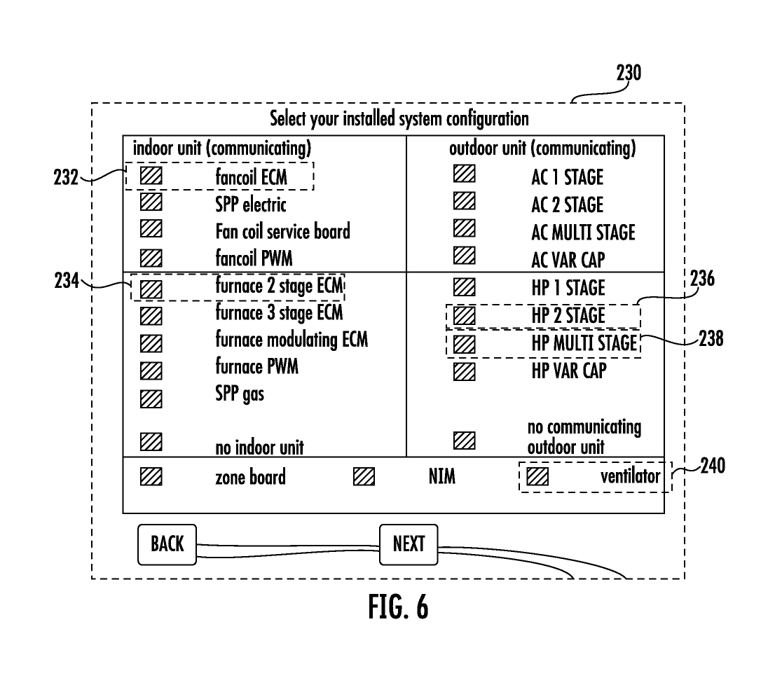

In one embodiment, the method 300 includes the step 302 of interacting with the configuration module 230 to select at least one component for simulation. For example, the user is presented with a listing of HVAC components for simulation. In the example shown in FIG. 6, the user may select from an indoor unit consisting of a fan coil at 232 or a furnace at 234. The user may also select from an outdoor unit consisting of a two-stage heat pump at 236 or a multi-stage heat pump at 238. Additionally, the user may select an accessory, for example a ventilator at 240, for simulation. In this embodiment, the context relative information 222 and 224 is based at least on the selected at least one component and the interactions with the simulated user interface 210.

It will be appreciated that the user may select any single component or a combination thereof for simulation. It will also be appreciated that the configuration module 230 is configured to determine whether the selected components are a valid selection. For example, if the user attempts to select a heat pump unit and an air conditioning unit for simulation, configuration module 230 may generate an error message prompting to user to select a valid combination for simulation because a heat pump unit and an air conditioning unit is an incompatible HVAC configuration for simulation. It will further be appreciated that the configuration module 230 may disable the selection of certain components after the first selection is made to reduce the likelihood of selecting incompatible components to make up the simulated system.

In one embodiment, the method 300 further includes the step 304 of interacting with the configuration module 230 to select a user defined role. In this embodiment, the context relative information 222 and 224 is based at least in part on the selected at least one component, the selected user defined role and the interactions with the simulated user interface 210. For example, after selecting the at least one component for simulation, the configuration module prompts the user to select a user defined role. If the user identifies as an internal user, such as software engineer to name one non-limiting example, the context relative side-bar 220 may dynamically display information regarding the validation and usability requirements for the simulated user interface 210. As another example, if the user identifies as an external user, such as a homeowner to name one non-limiting example, the context relative side-bar 220 may dynamically display information from an owner's manual file from storage 150.

It will therefore be appreciated that the simulated user interface 210 and context relative side-bar 220 provide an easy and efficient means of simulating the operation of a system, and display context relevant information based on a user's interaction with the system. It will also be appreciated that simulated user interface 210 and context relative side-bar 220 allows for consistency and efficiency when developing systems and provides a strong linkage between product documentation and product lifecycles, to enhance the user experience and quality of products within the system.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A device for displaying context relative content of a system using an interactive simulator comprising:
a processor, a memory, a display;
one or more programs stored in said memory and configured to be executed by said processor, wherein said programs are configured to:
simulate commands to operate a system; and
operate a graphical user interface on said display, said graphical user interface comprising a simulated user interface of said system, and a context relative side-bar.

2. The device of claim 1, wherein the graphical user interface further comprises a configuration module, the configuration module is configured to allow a user to select at least one component for simulation.

3. The device of claim 2, wherein said configuration module is further configured to allow a user to select a user defined role.

4. The device of claim 3, wherein the system comprises an HVAC system.

5. The device of claim 4, wherein said simulated user interface is configured to simulate an HVAC system controller.

6. The device of claim 5, wherein the at least one component is selected from a group consisting of indoor units, outdoor units, and accessories.

7. The device of claim 1, wherein said context relative side-bar is configured to dynamically display context relative information based at least in part on interactions with the simulated user interface.

8. The device of claim 3, wherein said context relative side-bar is configured to dynamically display context relative information based at least in part on the selected at least one component and the selected user defined role.

9. The device of claim 3, wherein said user defined role is selected from a group consisting of internal users and external users.

10. A method of displaying context relative information on a device, the device being configured to run one or more programs, wherein said programs simulate commands to operate a system and operate a graphical user interface, said graphical user interface including a simulated user interface, and a context relative side-bar, the method comprising the steps of:
(a) interacting with the simulated user interface; and
(b) dynamically displaying context relative information in the context relative side-bar.

11. The method of claim 10, wherein the context relative information is based at least in part on the interactions with the simulated user interface.

12. The method of claim 10, wherein the graphical user interface further includes a configuration module.

13. The method of claim 12, wherein the prior to step (a) the method further comprises interacting with the configuration module to select at least one component for simulation.

14. The method of claim 13, further comprising interacting with the configuration module to select a user defined role.

15. The method of claim 10, wherein the system comprises an HVAC system.

16. The method of claim 13, wherein the at least one component is selected from a group consisting of indoor units, outdoor units, and accessories.

17. The method of claim 13, wherein the context relative information comprises information based at least in part on the selected at least one component and the interactions with the simulated user interface.

18. The method of claim 14, wherein the context relative information comprises information based at least in part on the selected at least one component, the selected user defined role and the interactions with the simulated user interface.

19. The method of claim 14, wherein the user defined role is selected from a group consisting of internal users and external users.
